(19) United States
(12) Patent Application Publication
(10) Pub. No.: US 2013/0256473 A1
(43) Pub. Date: Oct. 3, 2013

(54) Stand for Electronic Device

(71) Applicant: Duane Ray DeBoef, Ankeny, IA (US)

(72) Inventor: Duane Ray DeBoef, Ankeny, IA (US)

(21) Appl. No.: 13/829,873

(22) Filed: Mar. 14, 2013

Related U.S. Application Data
(60) Provisional application No. 61/619,065, filed on Apr. 2, 2012.

(51) Int. Cl. F16M 13/02

(52) U.S. Cl. CPC F16M 13/02
USPC 248/146; 248/188.1

(57) ABSTRACT

Provided is a stand that may be installed in an automobile. The stand may include a base which may be insertable into a component, for example, a cup holder, of an automobile. The stand may further include an arm extending from the base and the arm may be configured to extend to another component of the automobile. The stand may also include a shaft connected to the base and a platform connected to the shaft.

### CROSS-REFERENCE TO RELATED APPLICATIONS

This application claims priority to U.S. Provisional Patent Application No. 61/619,065 filed on Apr. 2, 2012 in the United States Patent and Trademark Office, the entire contents of which is herein incorporated by reference.

### BACKGROUND

1. Field

Example embodiments relate to a stand which may be used to support an electronic device. In example embodiments the stand may be configured to fit in an automobile to support a device such as a portable laptop computer.

2. Description of the Related Art

Laptop computers are used for a variety of purposes. For example, some users use a laptop computer for entertainment while others use the laptop computer for business purposes. Due to the portability of laptop computers, many users operate the laptop computers in an automobile, for example, a car. While a user can operate a laptop computer by simply holding the laptop computer or placing the laptop computer in the user's lap, such a method is somewhat clumsy and may render the computer difficult to use. Thus, some users have turned to car-mounted computer stands to provide a platform upon which the user can place his/her computer. Such stands, however, are generally expensive, take up considerable space, and are often difficult to install.

### SUMMARY

Example embodiments relate to a stand that may be used to support an electronic device, for example, a laptop computer. In example embodiments the stand may include a base, an arm, a shaft, and a platform. The stand may be insertable into a component of a car, for example, a cup holder. The arm may extend from the base and may be configured to insert into a storage compartment of the automobile. In the alternative, the arm may be configured to press against a console housing the car's cup holder. In this latter embodiment, the arm may provide a clamping force against the console. The shaft may be configured to connect the platform to the base and may be configured to move the platform towards and away from the base. In example embodiments, the shaft may be further configured to allow the platform to rotate relative to the base.

In accordance with example embodiments, the stand may be removably installed in an automobile. Once installed in the automobile, a computer may be mounted on the platform of the stand. In example embodiments, various securing devices and/or structures may be used to secure the computer to the platform. For example, the platform may be covered by a Velcro like material which may allow a laptop computer to attach to the platform. In the alternative, clips may be provided to secure the laptop computer to the platform.

### BRIEF DESCRIPTION OF THE DRAWINGS

Example embodiments are described in detail below with reference to the attached figures, wherein:

FIG. 1 is a view of a stand in accordance with example embodiments;

FIG. 2A is a side view of the stand in accordance with example embodiments;

FIG. 2B is a side view of the stand with a platform rotated in accordance with example embodiments;

FIG. 3 is another side view of the stand in accordance with example embodiments;

FIG. 4A is a partial view of the stand in accordance with example embodiments;

FIG. 4B is another partial view of the stand in accordance with example embodiments;

FIG. 5 is a portion of a section view of a conventional automobile showing a cup holder and a closed storage unit;

FIG. 6 is a portion of a section view of a conventional automobile showing a cup holder and an open storage unit;

FIG. 7 is a view of the stand being inserted into a cup holder and a storage unit of the conventional automobile in accordance with example embodiments;

FIG. 8 is a view of the stand installed in the conventional automobile in accordance with example embodiments;

FIG. 9 is a view of a stand in accordance with example embodiments;

FIG. 10 is a view of a stand in accordance with example embodiments;

FIG. 11 is a view of a stand in accordance with example embodiments;

FIG. 12 is a view of a stand in accordance with example embodiments;

FIG. 13A is a partial view of a stand in accordance with example embodiments;

FIG. 13B is a partial view of a stand in accordance with example embodiments;

FIG. 14A is a view of a stand in accordance with example embodiments;

FIG. 14B is a view of a stand in accordance with example embodiments;

FIG. 15A is a view of a connecting structure in accordance with example embodiments;

FIG. 15B is a view of a base in accordance with example embodiments;

FIGS. 16A-16D represent various configurations of a stand in accordance with example embodiments;

FIG. 17 is a view of a stand in accordance with example embodiments;

FIG. 18 is a view of an adjustment assembly in accordance with example embodiments;

FIGS. 19A-19C are views of a base in accordance with example embodiments;

FIGS. 20A-20B are views of a pushrod in accordance with example embodiments;

FIGS. 21A-21C are views of a cylindrical member in accordance with example embodiments;

FIGS. 22A-22B are views of a threaded member in accordance with example embodiments;

FIGS. 23A-23E are views of and adjustment assembly being inserted into a base in accordance with example embodiments; and

FIGS. 24A and 24B are views of a stand inserted into a cupholder of a car.

### DETAILED DESCRIPTION

Example embodiments of the invention will now be described with reference to the accompanying drawings. Example embodiments, however, should not be construed as limiting the invention since the invention may be embodied in different forms. Example embodiments illustrated in the figures are provided so that this disclosure will be thorough and complete. In the drawings, the sizes of components may be exaggerated for clarity.

In this application, when an element is referred to as being “on,” “attached to,” “connected to,” or “coupled to” another element, it can be directly on, attached to, connected to, or coupled to the other element or intervening elements that may be present. On the other hand, when an element is referred to as being “directly on,” “directly attached to,” “directly connected to,” or “directly coupled to” another element, there are no intervening elements present. In example embodiments, when an element is referred to as “contacting” another element, it may directly contact the other element or contact an intervening element that may be present. In this application, when an element is referred to as “directly contacting” another element, there is no intervening element. As used herein, the term “and/or” includes any and all combinations of one or more of the associated listed items.

In this application, the terms first, second, etc. are used to describe various elements, components, regions, layers, and/or sections. However, these elements, components, regions, layers, and/or sections should not be limited by these terms since these terms are only used to distinguish one element, component, region, layer, and/or section from other elements, components, regions, layers, and/or sections that may be present. For example, a first element, component region, layer or section discussed below could be termed a second element, component, region, layer, or section.

In this application, spatial terms, such as “beneath,” “below,” “lower,” “over,” “above,” and “upper” (and the like) are used for ease of description to describe one element or feature's relationship to another element(s) or feature(s). The invention, however, is not intended to be limited by these spatial terms. For example, if an example of the invention illustrated in the figures is turned over, elements described as “over” or “above” other elements or features would then be oriented “under” or “below” the other elements or features. Thus, the spatial term “over” may encompass both an orientation of above and below. The device may be otherwise oriented (for example, rotated 45 degrees, 90 degrees, 180 degrees, or at other orientations) and the spatially relative descriptors used herein interpreted accordingly.

In this application, example embodiments may be described by referring to plan views and/or cross-sectional views which may be ideal schematic views. However, it is understood the views may be modified depending on manufacturing technologies and/or tolerances. Accordingly, the invention is not limited by the examples illustrated in the views, but may include modifications in configurations formed on the basis of manufacturing process. Therefore, regions illustrated in the figures are schematic and exemplary and do not limit the invention.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a stand which may be used to support an electronic device. In example embodiments the stand may be configured to fit in an automobile to support a device such as a portable laptop computer.

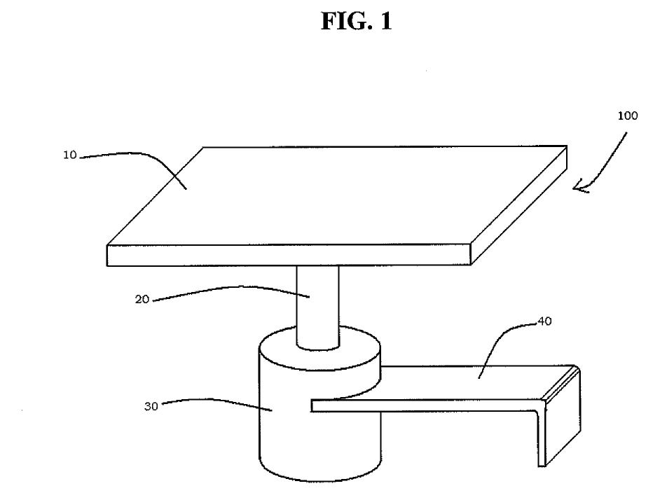

FIG. 1 is a view of a stand 100 in accordance with example embodiments. As shown in FIG. 1, the stand 100 may include a platform 10, a shaft 20, a base 30, and an arm 40. In example embodiments, platform 10 may be configured to support an electronic device, for example, a laptop computer. The shaft 20 may be configured to attach the platform 10 to the base 30 in a manner that allows the platform 10 to rotate with respect to the base 30 and the shaft 20. The base 30 may be configured to fit within a first element of a conventional automobile, for example, a cup holder of a car. Although the shape of the base 30 is illustrated as being cylindrical, the shape may vary depending on the first element of the conventional automobile to which the base 30 is configured to fit. The arm 40 may extend from the base 30 and may be configured to extend to a second element of the conventional automobile, for example, a storage compartment of the automobile.

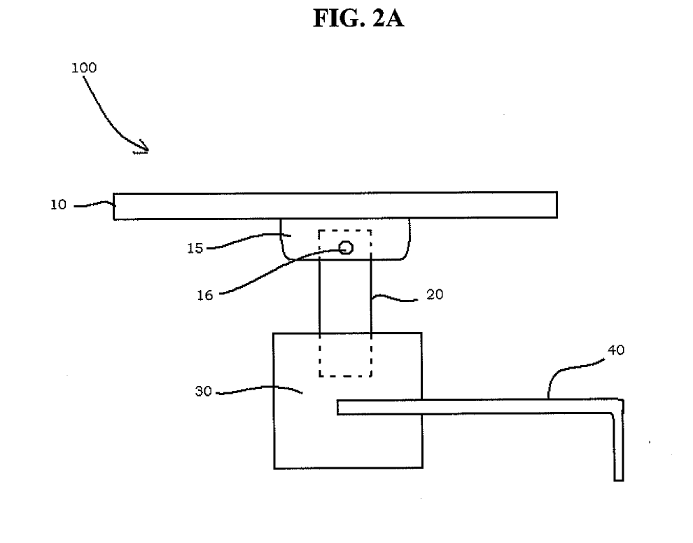

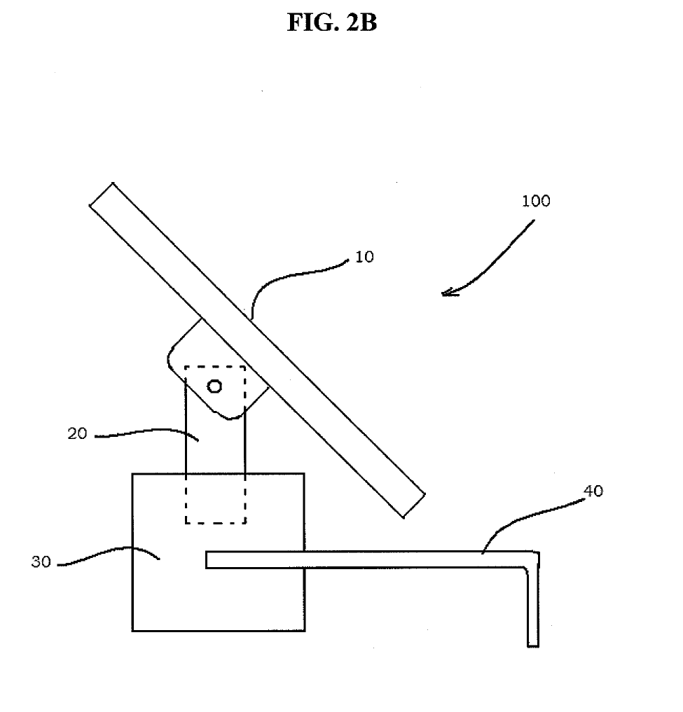

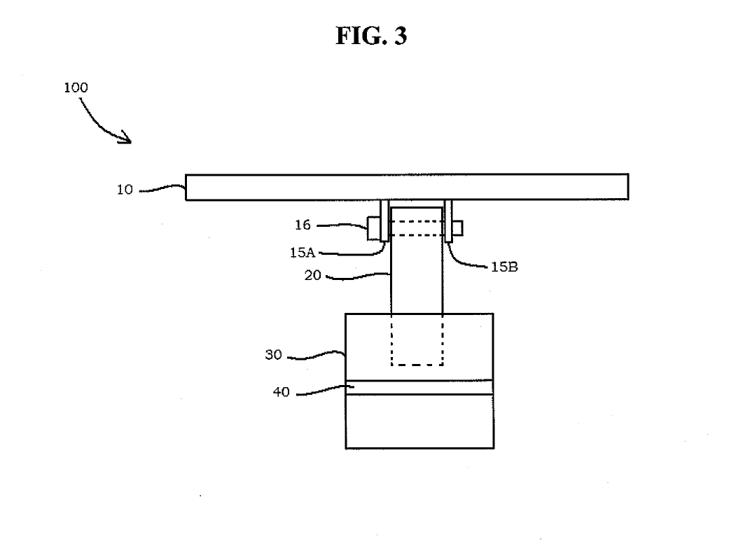

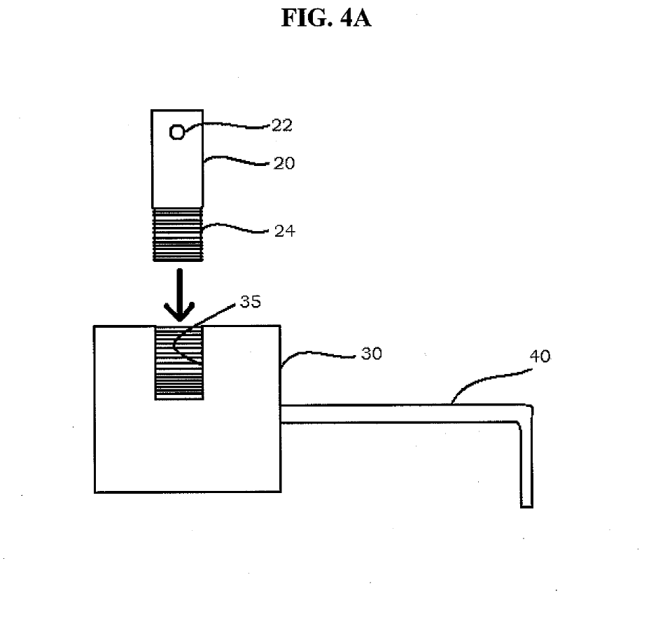

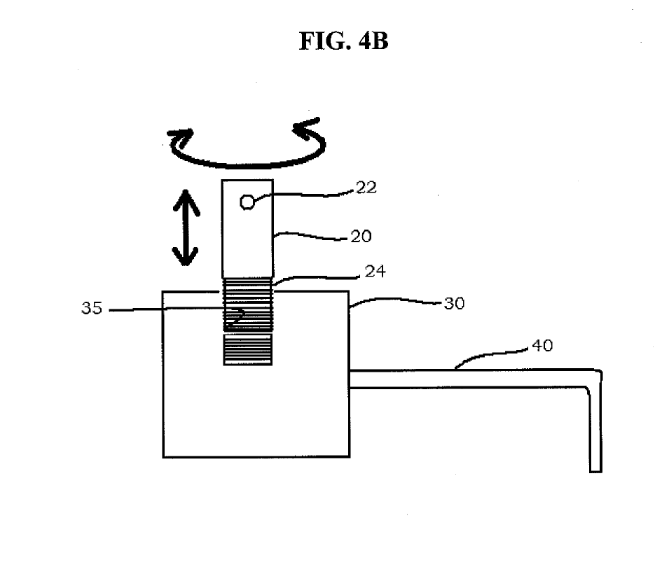

FIGS. 2A, 2B, and 3 are side views of the stand 100 in accordance with example embodiments. As shown in FIG. 2A, the platform 10 may be connected to the shaft 20 via a connecting structure 15, for example, a bracket. In example embodiments, the connecting structure 15 may, for example, include a first member 15A and a second member 15B each having a hole through which a connecting member 16, for example, a pin or a bolt, may pass. The connecting member 16 may also pass through holes 22 provided near an end of the shaft 20 (see FIG. 4A). In example embodiments, the connecting structure 15 may be connected to the platform 10 by a conventional means such as bolting, pinning, screwing, welding, and and/or riveting. Example embodiments, however, are not limited thereto. For example, the platform 10 and the connecting structure 15 may be formed as one integral structure via a casting process. Due to the manner in which the platform 10 is connected to the shaft 20, the platform 10 may be rotated about the pin 16, as shown in FIG. 2B, thus allowing the platform 10 to be in an inclined position as shown in FIG. 2B.

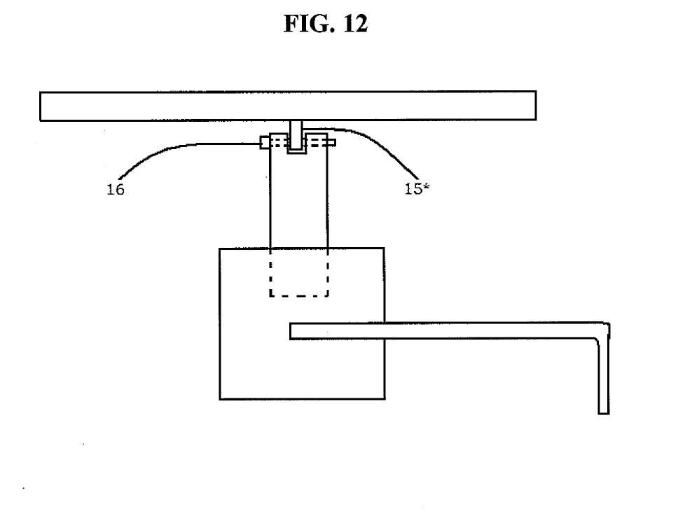

Although FIGS. 2A, 2B, and 3 show an example of how the platform 10 and the shaft 20 may be connected, example embodiments are not limited thereto. For example, referring to FIG. 12, an end of the shaft 20 may be slotted to allow a single connecting member 15* to be inserted therein. In this configuration, a connecting member 16, such as a pin or a bolt, may be inserted into holes that may be formed at the end of the shaft 20 and the connecting member 15* to provide a connection which allows the platform to rotate relative to the shaft 20.

FIGS. 4A and 4B show a partial exploded view of the stand 100. As shown in FIGS. 4A and 4B, the shaft 20 may include an end that has external threading 24. Base 30, may include substantially cylindrical passage into which the shaft 20 may be inserted. In example embodiments, the substantially cylindrical passage may include internal threads 35 configured to engage the external threads 24 of the shaft 20. Thus, as shown in FIG. 4B, as the shaft 20 is inserted into the cylindrical passage and turned, the shaft 20 may move up and down with respect to the base 30. Because the platform 10 may be attached to the shaft 20, the platform 10 may also move up and down, with respect to the base 30, as the shaft 20 is turned.

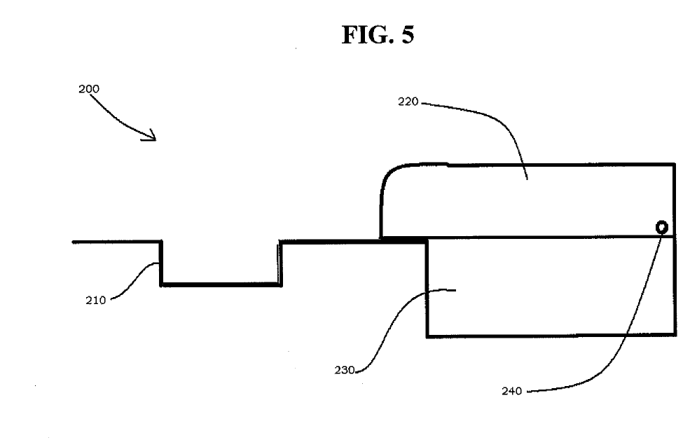

FIGS. 5-9 illustrate a use of the stand 100 in accordance with example embodiments. In particular, FIG. 5 represents a profile of a section of an automobile 200. In this example, the automobile includes a cup holder 210 and a storage unit 230 that is covered by a door 220. In this example, the door 220 may be attached to a pin 240 to allow the door to open and close as is shown in the figures. In FIG. 5, the storage unit 230 is shown in a closed position.

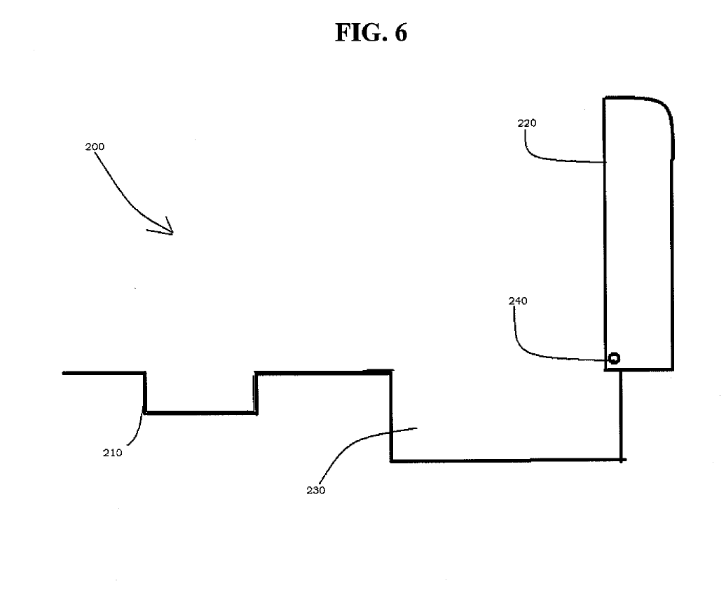

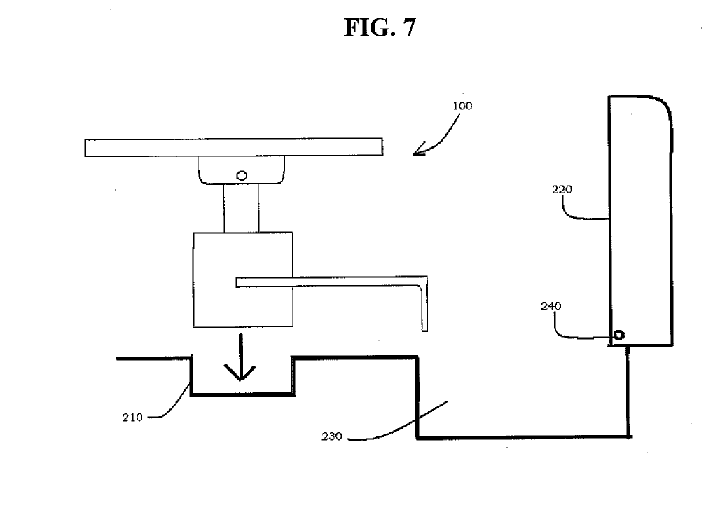

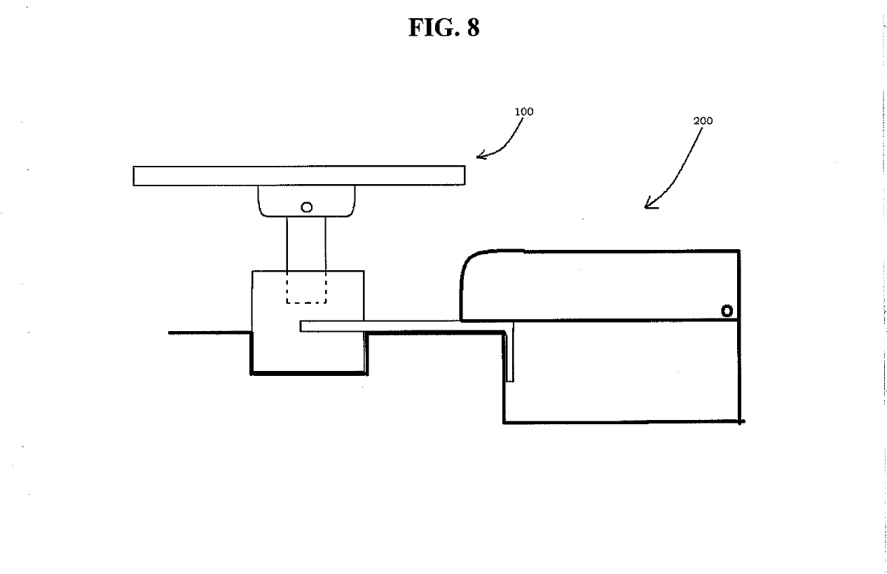

As shown in FIG. 6, the door 220 of the storage unit 230 may be opened to expose an inner space of the storage unit. As show in FIG. 7, the stand 100 may be arranged so that the base 30 of the stand 100 is inserted into the cup holder 210 and an end of the arm 40 is inserted into the storage unit 230. The stand may be “locked” into place by simply closing the door 220 as shown in FIG. 8.

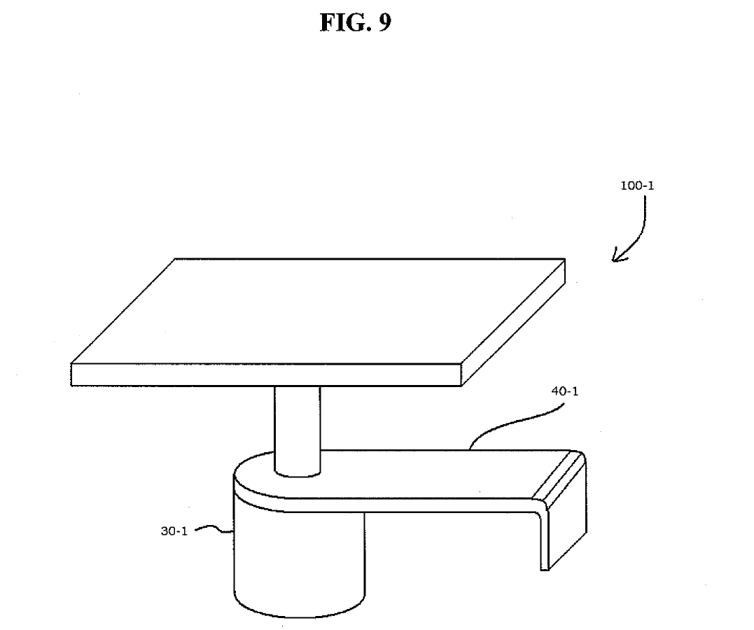

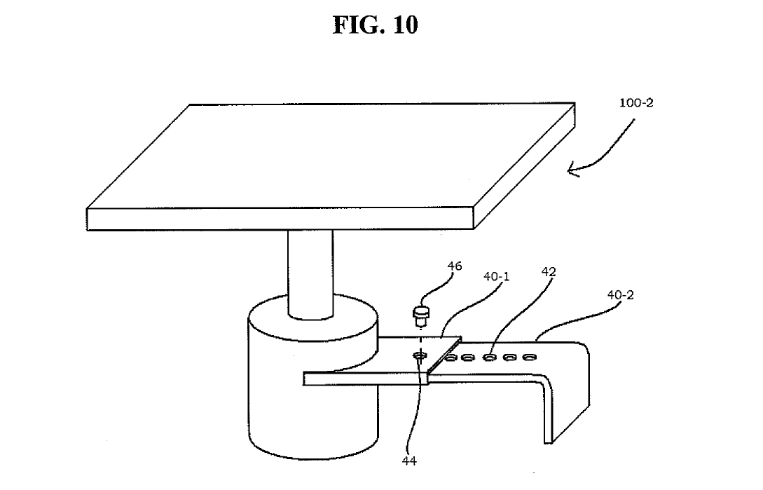

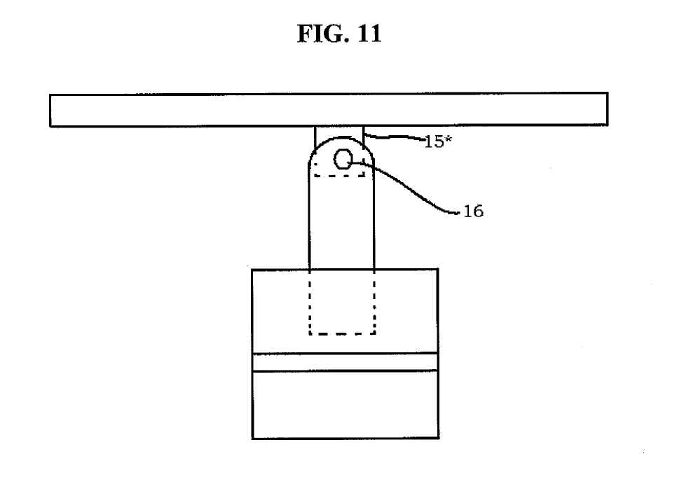

Although FIGS. 1-8 provide an example of a stand 100 in accordance with example embodiments, the invention is not limited thereto. For example, FIG. 9 illustrates another nonlimiting example of a stand 100-1 which has an arm 40-1 arranged on a top of a base 30-1 (rather than at a side of a base). Furthermore, example embodiments are not limited to stands having arms with a fixed length. For example, FIG. 10 illustrates an embodiment of a stand 100-2 wherein the arm is adjustable. In this example, the arm may be comprised of two telescoping members 40-1 and 40-2 wherein one of the telescoping members 40-2 includes a plurality of holes 42 one of which may be slid inline with a fixing hole 44 provided in the other telescoping member 40-1. In this particular nonlimiting example, the two telescoping members may be locked together by a locking member 46, such as a pin or bolt. In example embodiments, the spacing of the holes may be determined according to conventional automobiles.

In example embodiments the stand 100 may be configured to support various electronic devices. For example, the stand may be configured to support a computer. The electronic devices may be attached to the stand by various devices. For example, in one embodiment, clips may be provided on the platform 10 to secure the computer to the platform 10. In another embodiment, a material such as Velcro may be applied to a top surface of the platform 10 to attach a computer thereto. In another example, the platform 10 may include a recessed area into which the laptop computer may be inserted. In this example, the recessed area may include multiple recesses to accommodate various standard laptops.

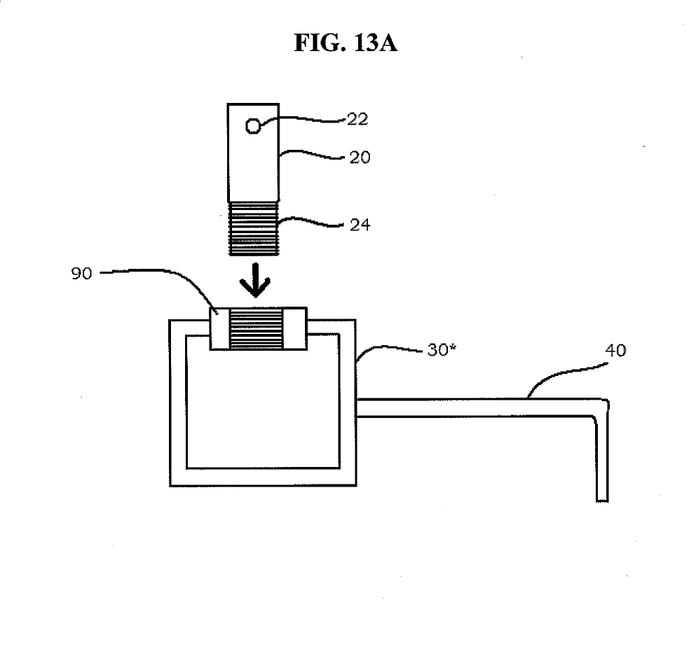

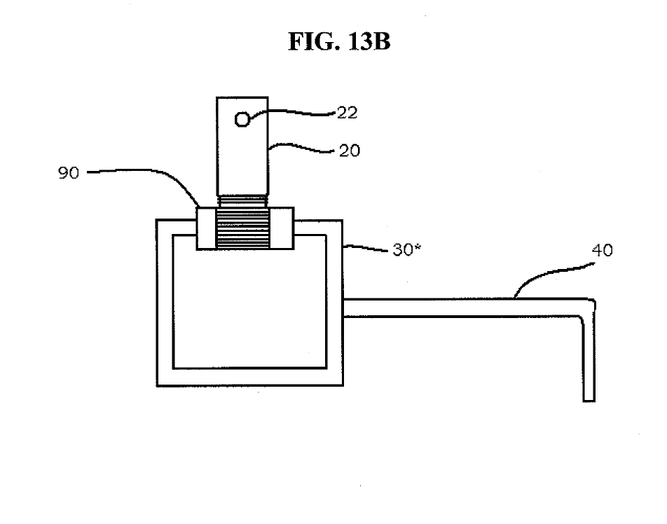

FIGS. 13A and 13B illustrate an alternative embodiment of a stand in accordance with example embodiments. In FIGS. 13A and 13B a platform and its connecting structures are not shown. In FIG. 13A, the shaft 20 may be substantially the same as the shaft 20 illustrated in FIGS. 4A and 4B, thus a detailed description thereof is omitted for the sake of brevity. However, in FIG. 13A, the base 30* is represented as a substantially hollow member that has a bushing 90 secured thereto. The bushing 90 may be internally threaded to engage the external threads 24 of the shaft 20. Thus, when the shaft 20 is mated with the bushing 90 (see FIG. 13B), the shaft 20 may move towards or away from the base 30* as the shaft 20 is turned.

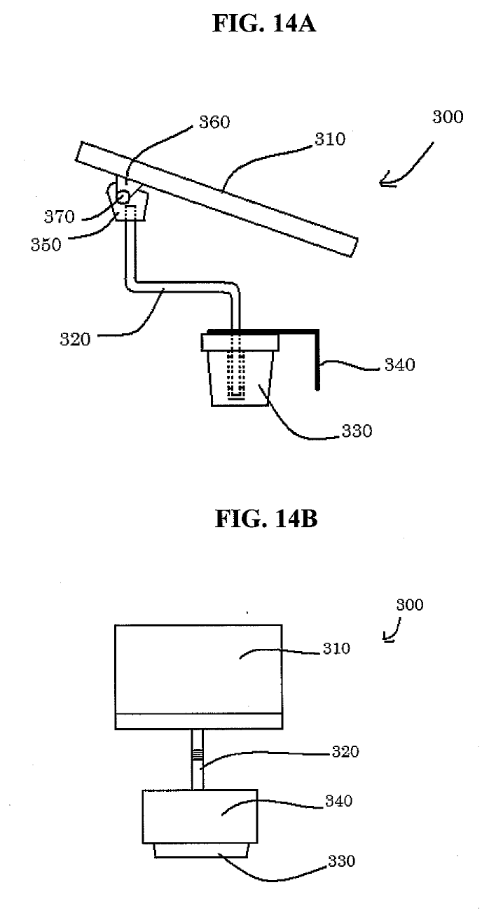

FIGS. 14A and 14B represent a stand 300 in accordance with example embodiments. As shown in FIGS. 14A and 14B, the stand 300 may include a base 330, an arm 340 attached to the base 330, a shaft 320 attached to the base 330, a connecting structure 350 attached to the shaft 320, a bracket 360 connected to the connecting structure 350, and a platform 310 connected to the bracket 360. In example embodiments, the connecting structure 350 may be attached to the bracket 360 via a connecting member 370, such as, but not limited to, a pin or screw. As in the previous nonlimiting example embodiments, the platform 310 may be configured to support electronic equipment, for example, a computer. Similarly, the base 330 may be configured to fit into a component of a car, for example, a car's cup holder. As shown in FIG. 14A, the shaft 320 may have an irregular shape, for example, a Z-shape, however example embodiments are not limited thereto as the shaft could have, but is not limited to, an S-shape, an L-shape, or an arc shape.

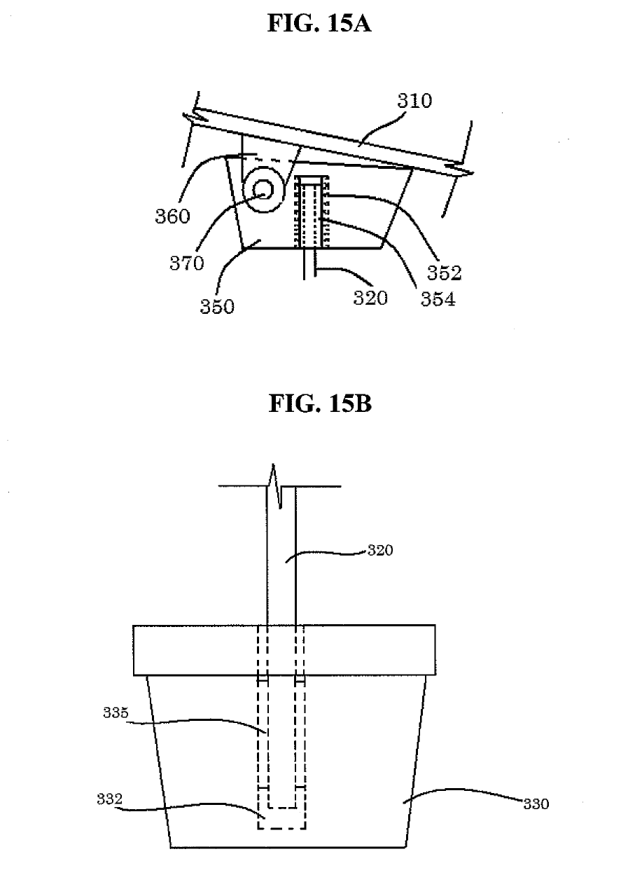

FIGS. 15A and 15B represent close-up views of the connecting structure 350 and the base 330. In example embodiments, the connecting structure 350 and the base 330 may be made from a plastic, for example, UHMW plastic. Example embodiments, however, are not limited thereto as the connecting structure 350 and base 330 may be made from other materials such as a metal or a ceramic. Referring to FIG. 15A it is noted that the connecting structure 350 includes a hole 352 that extends into the connecting structure 350. In example embodiments, the hole 352 may include internal threads. Also, the hole 352 should be large enough so that an end of the shaft 320 may be inserted therein. For example, if the shaft 320 has a circular cross-section and the circular cross-section has a diameter of about 0.5 inches, the hole 352 should have a diameter of larger than about 0.5 inches. Referring again to FIG. 15A, it is noted that an elastic material 354, for example, a rubber hose, or a braided hydraulic hose, may line the hole 352 formed in the connecting structure 350. Thus, in example embodiments, an elastic material may be provided between the end of the shaft 320 and walls of the connecting structure 350 that form the hole 352. Also, although the hole 352 formed in the connecting structure 350 may be threaded, the end of the shaft 320 which is inserted into the hole 352 is not required have threads.

Referring to FIG. 15B it is noted that the base 330 includes a hole 332 that extends into the base 330. In example embodiments, the hole 332 may include internal threads. Also, the hole 332 should be large enough so that an end of the shaft 320 may be inserted therein. For example, if the shaft 320 has a circular cross-section and the circular cross-section has a diameter of about 0.5 inches, the hole 332 should have a diameter of larger than about 0.5 inches. Referring again to FIG. 15B, it is noted that an elastic material 335, for example, a rubber hose, or a braided hydraulic hose, may line the hole 332 formed in the base 330. Thus, in example embodiments, an elastic material may be provided between the end of the shaft 320 and walls of the base 330 that form the hole 332. Also, although the hole 332 formed in the base 330 may be threaded, the end of the shaft 320 which is inserted into the hole 332 is not required have threads.

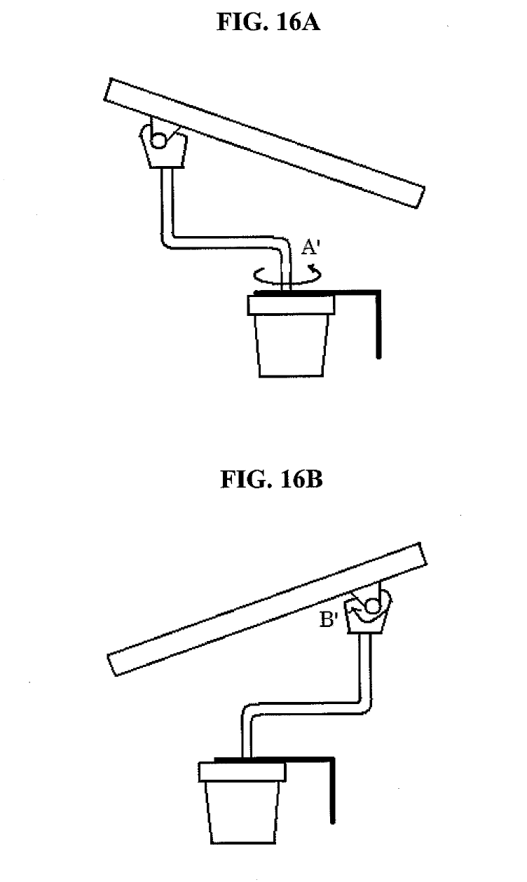

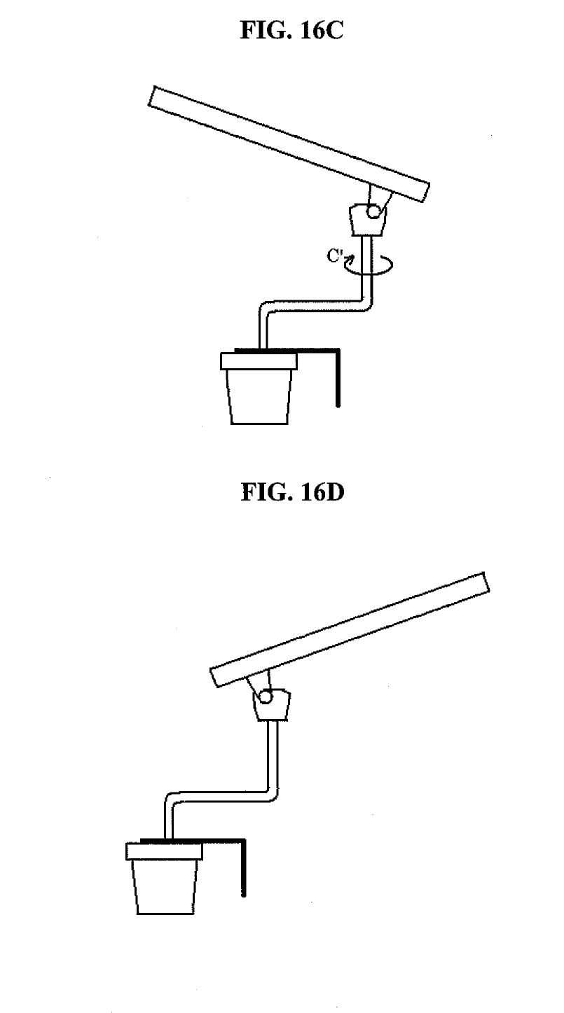

Referring to FIGS. 16A-16D, it is noted that the stand 300 includes multiple degrees of freedom which allow the stand to have various configurations. FIG. 16A, for example, illustrates an example of a first configuration. In example embodiments, the shaft 320 may be rotated in the hole 332 of the base 300, the direction of rotation being noted as A′ in FIG. 16A. Thus, in example embodiments, the stand 300 may be manipulated to a second configuration as shown in FIG. 16B. Referring to FIG. 16B, it is noted that because the bracket 360 and the connecting structure 350 may be connected by a pin or screw 370, the platform 310 may be rotated upwards to manipulate the stand 300 into a third position illustrated in FIG. 16C, the direction of rotation be noted as B′. Referring to FIG. 16C, it is noted that because the shaft 320 may be rotated within the hole 352 of the connecting structure 350, the platform 310 may be rotated around to manipulate the stand 300 into a fourth position illustrated in FIG. 16D, the direction of rotation be noted as C′. In short, example embodiments provide a stand with incredible versatility where the platform may be rotated 360 degrees by either rotating the shaft within the base or by rotating the platform about the shaft. In addition, the connecting structure allows the platform to rotate up to about 105 degrees in a vertical plane.

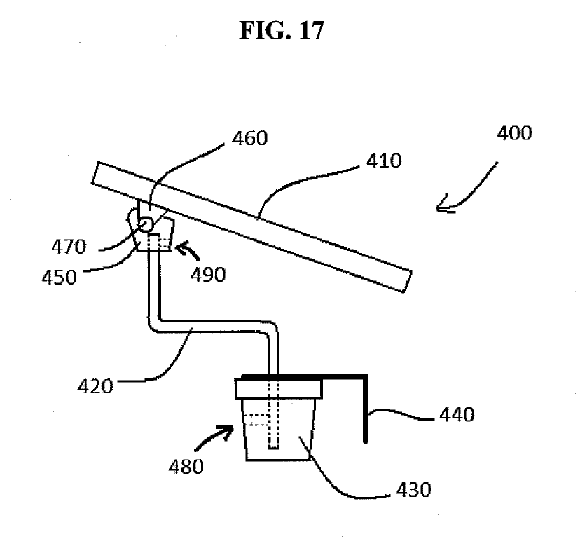

FIG. 17 represents a stand 400 in accordance with example embodiments. As shown in FIG. 17, the stand 400 may include a base 430, an arm 440 attached to the base 430, a shaft 420 attached to the base 430, a connecting structure 450 attached to the shaft 420, a bracket 460 connected to the connecting structure 450, and a platform 410 connected to the bracket 460. In example embodiments, the connecting structure 450 may be attached to the bracket 460 via a connector 470, for example, a pin or a screw. As in the previous nonlimiting example embodiments, the platform 410 may be configured to support electronic equipment, for example, a computer. Similarly, the base 430 may be configured to fit into a component of a car, for example, a car's cupholder. As shown in FIG. 17, the shaft 420 may have an irregular shape, for example, a Z-shape, however example embodiments are not limited thereto as the shaft could have, but is not limited to, an S-shape, a straight shape, or an arc shape.

The stand 400 may be substantially the same as the stand 300 shown in FIGS. 14A and 14B. Thus, the stand 400 may achieve any of the configurations illustrated in FIGS. 16A to 16D. However, in example embodiments, the base 430 and the connecting structure 450 of the stand 400 are configured differently from the connecting structure 350 and the base 330 of the stand 300. For example, the base 430 may be configured to include a first adjustment assembly 480 and the connecting structure 450 may be configured to include a second adjustment assembly 490. In example embodiments, the first and second adjustment assemblies 480 and 490 may be configured to adjust tension between the shaft 420 and the base 430 and between the shaft 420 and the connecting structure 450. Thus, an amount of force necessary to rearrange the elements of the stand 400 to achieve different configurations may be varied. In example embodiments, the first and second adjustment assemblies 480 and 490 may be substantially similar, thus, only the first adjustment assembly 480 will be discussed in detail.

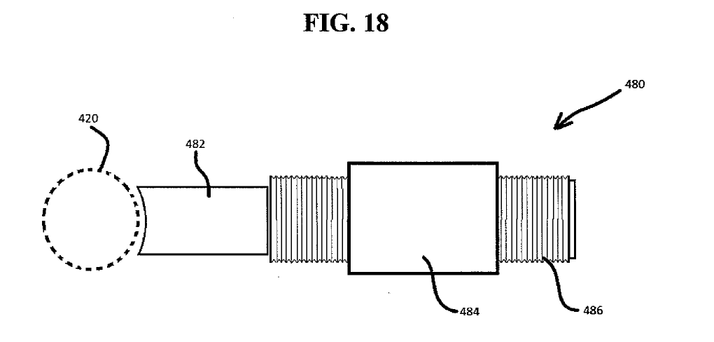

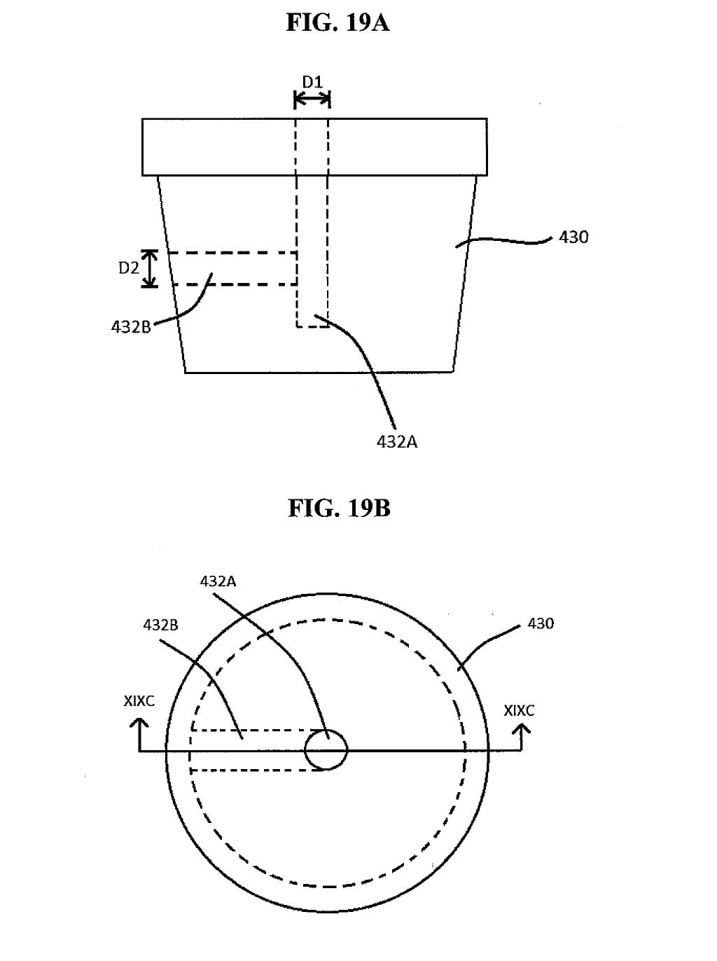

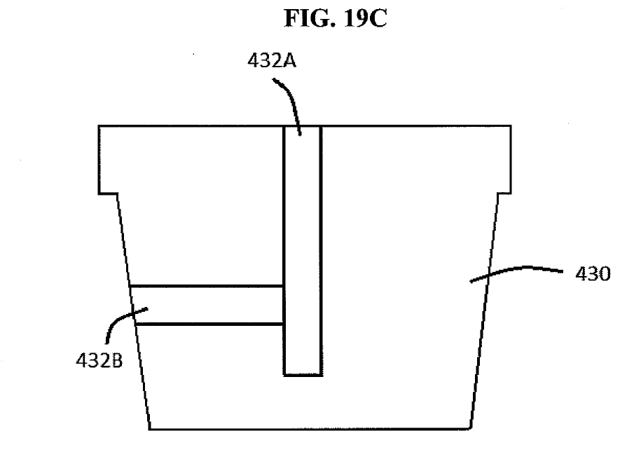

FIG. 18 illustrates a nonlimiting example of an adjustment assembly 480. As shown in FIG. 18, the adjustment assembly 480 may include a push rod 482, an internally threaded cylinder 484 and a threaded member 486. In example embodiments, the adjustment assembly 480 may be configured to insert into a hole that may be formed in the base 430. For example, FIGS. 19A-19C illustrate various views of the base 430 in accordance with example embodiments. For example, FIG. 19A illustrates a side view of the base 430. FIG. 19B illustrates a top view of the base 430, and FIG. 19C illustrates a section view of the base 430 taken through line XIXC-XIXC of FIG. 19B.

As shown in FIGS. 19A-19C, the base 430 may be formed with a first hole 432A and a second hole 432B. In example embodiments, the first hole 432A may have a substantially circular cross-section having a first diameter D1 and the second hole may have a circular cross-section having a second diameter D2. In example embodiments, the shaft 420 may be inserted into the first hole 432A, thus the first diameter D1 of the first hole 432A may be about the same as, or larger than, a diameter of the shaft 420.

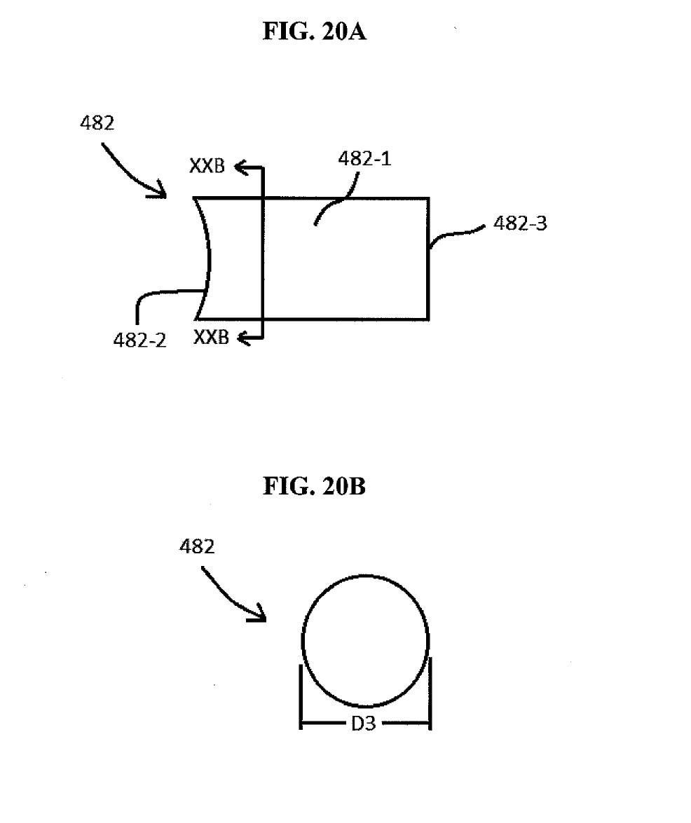

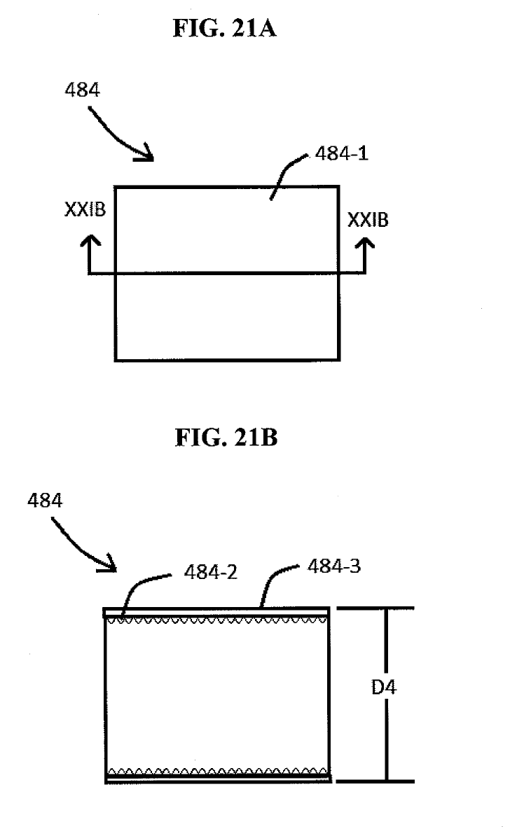

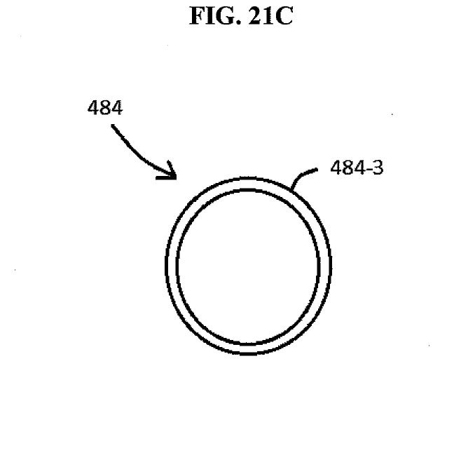

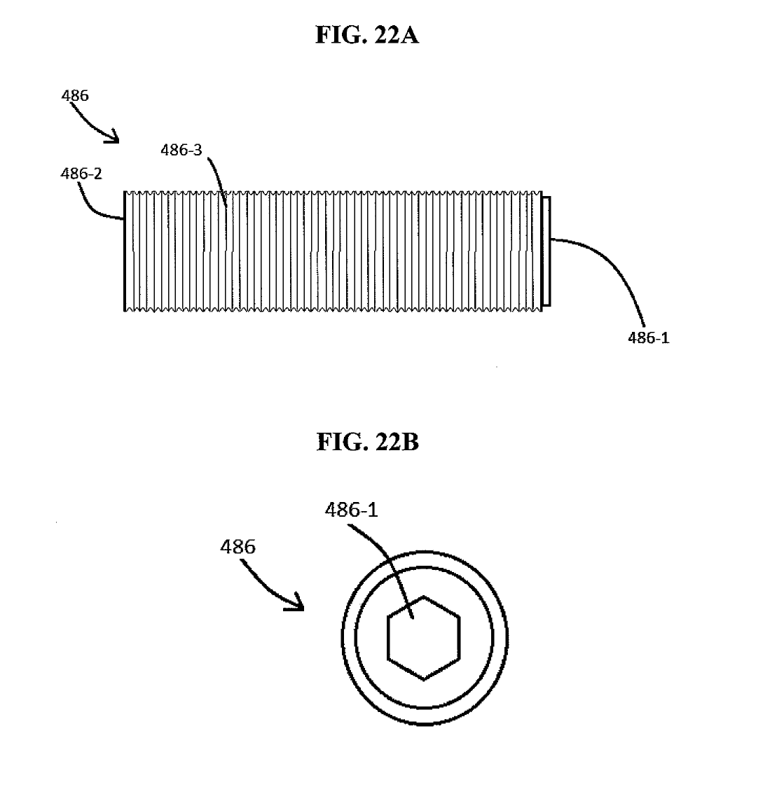

FIGS. 20A-22B illustrate various features of the adjustment assembly 480. For example, FIG. 20A illustrates a side view of the push rod 482 and FIG. 20B illustrates a cross-section view of the push rod 482 taken through line XXB-XXB of FIG. 20A. FIGS. 21A and 21C illustrates a top view and an end view of the internally threaded cylinder 484 and FIG. 21B illustrates a cross-section of the internally threaded cylinder 484 taken through line XXIB-XXIB of FIG. 21A, and FIGS. 22A and 22B illustrate a side view and an end view of the threaded member 486 in accordance with example embodiments.

Referring back to FIGS. 20A-20B, the push rod 482 in accordance with example embodiments may have a substantially cylindrical body 482-1, an interfacing end 482-2, and a pushed end 482-3. In example embodiments, a diameter D3 of the cylindrical body 482-1 may be about the same as, or smaller than the diameter D2 of the second hole 432B, thus, the cylindrical body 482-1 is insertable into the second hole 432B. In example embodiments, the interfacing end 482-2 may be curved to engage the shaft 420. For example, the interfacing end 482-2 may have the same curvature as a curvature of the shaft 420. This latter feature, however, is not intended to limit example embodiments as the interfacing end 482-2 is not required to have a curvature much less a curvature that matches the curvature of the shaft 420.

FIGS. 21A-21C illustrate an example of the internally threaded cylinder 484. As shown in FIGS. 21A-21C, the internally threaded cylinder 484 may have a substantially cylindrical body 484-1 with a cylindrical outer surface 484-3 and a threaded inner surface 484-2. In example embodiments, an outer diameter D4 of the internally threaded cylinder 484 may be about the same as, or slightly smaller than, the diameter D2 of the second hole 432B. Thus, the internally threaded cylinder 484 may be insertable into the second hole 432B.

FIGS. 22A-22B illustrate an example of the threaded member 486. In example embodiments, the threaded member 486 may have a threaded body 486-3 configured to engage the internal threads of the internally threaded cylinder 484. Thus, once inserted into the internally threaded cylinder 484, the threaded member 486 may move along the internally threaded cylinder 484 by rotating the threaded member 486 relative to the internally threaded cylinder 484. In example embodiments, a first end 486-2 of the threaded member 486 may be configured to push against the pushed end 482-3 of the push rod 482. A second end 486-1 of the threaded member 486 may be configured to interface with a tool. For example the second end 486-1 may include a depression configured to receive an alien wrench. Example embodiments, however, are not limited thereto. For example, the second end 486-1 may be configured with a cross-shaped depression configured to receive a Phillips screw driver. As another example, the second end 486-1 may be configured with a slotted depression to receive an end of a standard screw driver.

Although example embodiments illustrate the adjustment assembly as being comprised of a push rod 482, an internally threaded cylinder 484, and a threaded member 486, example embodiments are not limited thereto. For example, in the event the base 430 is comprise of a sufficiently strong and stiff material, the second hole 432B may be threaded such that the threaded cylinder 484 may be omitted entirely. Regardless, the adjustment assemblies 480 and 490 offer a significant advantage over the prior art at least because they are adjustable and at least because they accomplish tensioning without knobs or bolts.

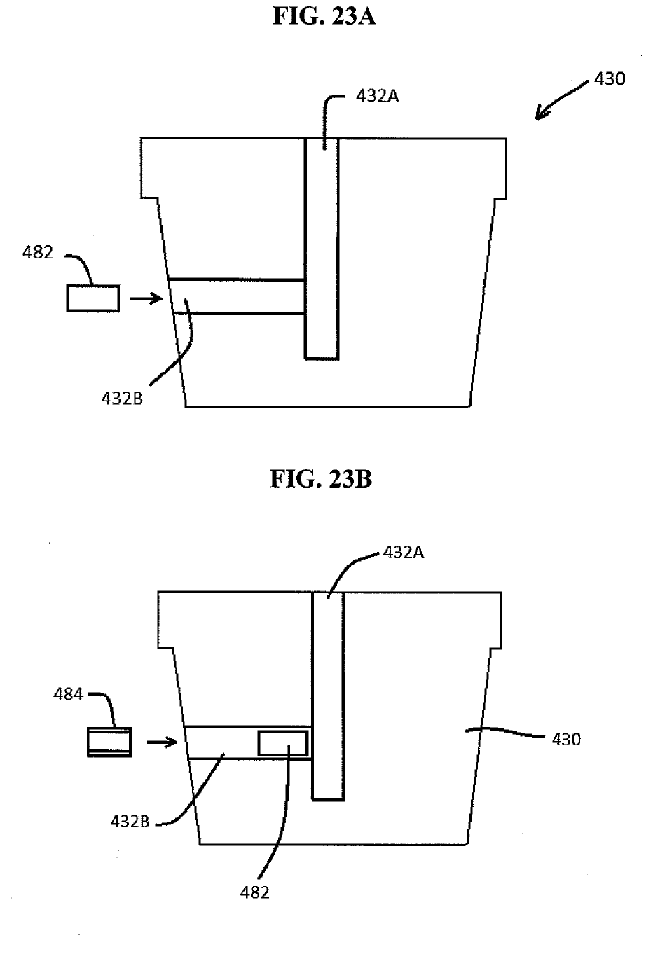

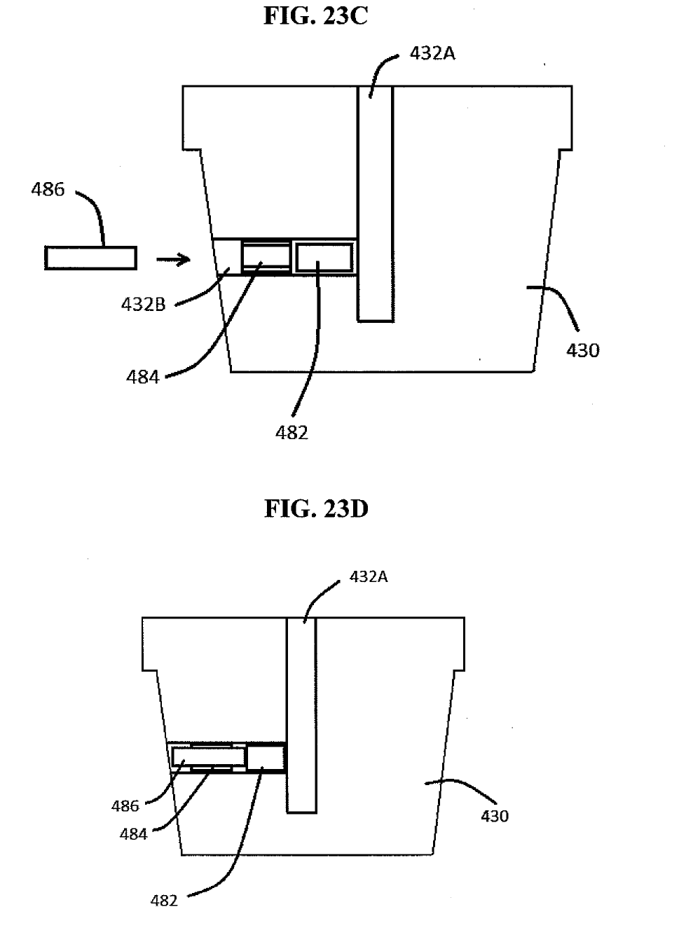

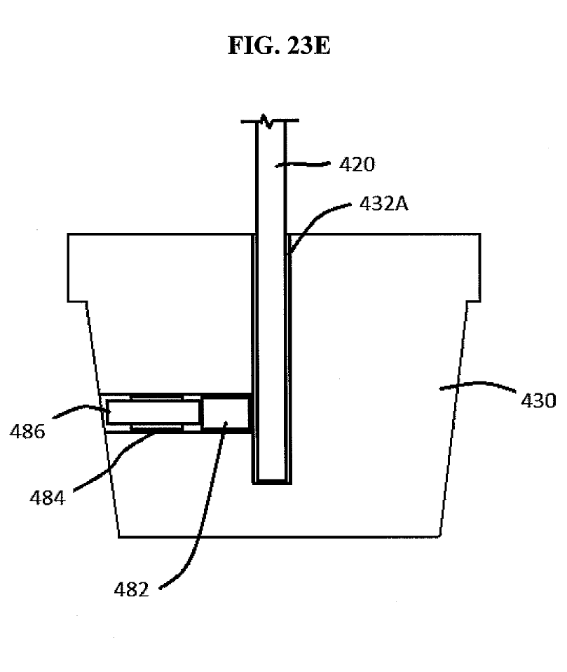

FIGS. 23A-23E illustrate an example of an installation of the first adjustment assembly 480 into the base 430 of example embodiments. As shown in FIG. 23A, the push rod 482 may be placed inside the second hole 432B of the base 430. After the push rod 482 is inserted, the internally threaded cylinder 484 may be placed in the second hole 432B. In example embodiments, outer surfaces of the internally threaded cylinder 484 may be coated with an adhesive to secure the internally threaded cylinder 484 in the second hole 432B. After the internally threaded cylinder 484 is inserted into the second hole 432B, the threaded member 486 may be inserted into the internally threaded cylinder 484 so that the threads of the threaded member 486 are engaged with the threads of the internally threaded cylinder 484. Once engaged, the threaded member 486 may be turned to advance the threaded member 486 along the internally threaded cylinder 484. Once advanced far enough, the threaded member 486 may contact the pushed end 482-3 of the push rod 482. As shown in FIG. 23E, the push rod 482 may, in turn, be pushed against the shaft 420 that may be inserted into the first hole 432A. In example embodiments, the force between the shaft 420 and the push rod 482 may be varied according to how hard the threaded member 486 is torqued by a user. If the torque applied to the threaded member 486 his high, the tension between the shaft 420 and the base 430 may be relatively high. Thus, tension between the shaft 420 and the base 430 may be controlled by controlling the amount of torque delivered to the threaded member 486.

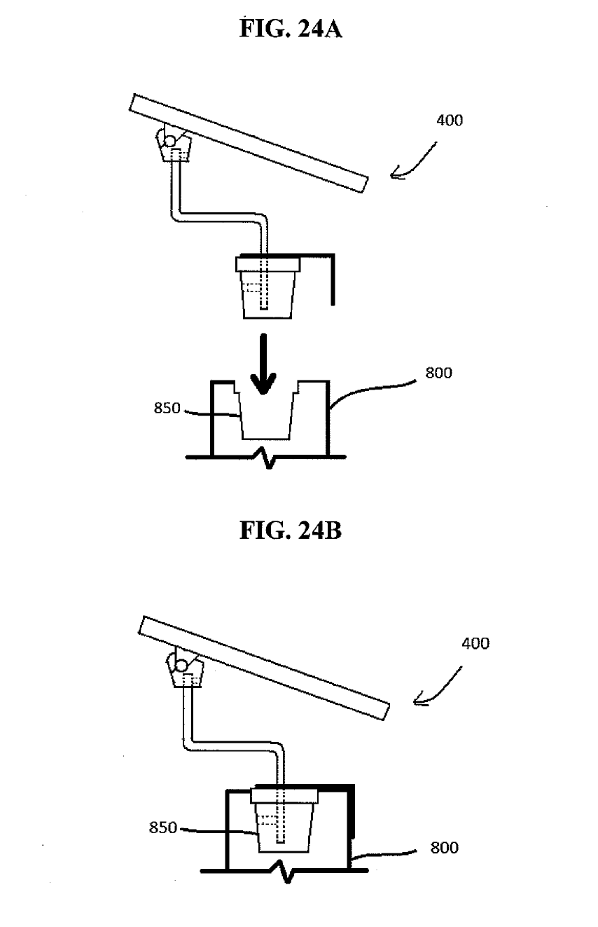

FIGS. 24A and 24B illustrate the stand 400 being inserted into a structure of an automobile. For example, in FIGS. 24A and 24B the stand 400 is illustrated as being placed into a cupholder 850 of a car. In this particular nonlimiting example embodiment, the arm 400 does not extend to a storage compartments as in a previous nonlimiting example embodiment, rather, it extends to an edge of a console 800 that supports the cupholder 850. In example embodiments, the arm 400 may be structured to provide a slight clamping on the console 800 to secure the stand 400 in place. However, in example embodiments, the arm 400 may also not be structured to provide a slight clamping force but may instead merely extend around the console 800.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A stand comprising:
a base insertable into a first component of a vehicle;
an arm extending from the base, the arm configured to extend to a second component of the vehicle;
a shaft connected to the base; and
a platform connected to the shaft.

2. The stand according to claim 1, wherein the platform is configured to rotate about the shaft and the shaft is configured rotate within the base.

3. The stand according to claim 2, further comprising:
a connecting structure connecting the shaft to the platform, wherein the shaft is configured to rotate within the connecting structure.

4. The stand according to claim 3, wherein the platform is configured to pivot about the connecting structure.

5. The stand according to claim 1, wherein the base includes a first hole and a second hole and the shaft is in the first hole.

6. The stand according to claim 5, wherein the first hole and the second hole are substantially perpendicular to one another.

7. The stand according to claim 5, further comprising:
a first adjustment assembly in the second hole.

8. The stand according to claim 7, wherein the first adjustment assembly includes a push rod, an internally threaded cylinder, and a threaded member.

9. The stand according to claim 8, wherein the push rod includes an interfacing end having a curvature which is substantially the same as a curvature of the shaft.

10. The stand according to claim 8, wherein the threaded member is configured to push the push rod against the shaft.

11. The stand according to claim 1, wherein the first component is a cup holder and the second component is a compartment.

12. The stand according to claim 1, wherein the first component is a cup holder and the second component is side of console that supports the cup holder.
